(19) United States
(12) Patent Application Publication
(10) Pub. No.: US 2020/0201585 A1
(43) Pub. Date: Jun. 25, 2020

(54) INFORMATION PROCESSING APPARATUS, METHOD OF CONTROLLING SAME, AND STORAGE MEDIUM

(71) Applicant: CANON KABUSHIKI KAISHA, Tokyo (JP)

(72) Inventor: Jun Miyajima, Toride-shi (JP)

(21) Appl. No.: 16/711,291

(22) Filed: Dec. 11, 2019

(30) Foreign Application Priority Data
Dec. 25, 2018 (JP) 2018-241727

(51) Int. Cl. G06F 3/12

(52) U.S. Cl. CPC G06F 3/1207; G06F 3/1288; G06F 3/1234; G06F 3/1232

(57) ABSTRACT

An information processing apparatus includes a registration unit and a reception unit. The registration unit can register a first image forming apparatus in a virtual printer. The reception unit receives capability information from the first image forming apparatus. The capability information includes at least information indicating that the first image forming apparatus executes an encrypted print job. The registration unit does not register a second image forming apparatus corresponding to predetermined capability information received by the reception unit. The predetermined capability information does not include information that the second image forming apparatus executes the encrypted print job.

### BACKGROUND

### Field

The present disclosure relates to an information processing apparatus, a method of controlling the same, and a storage medium.

### Description of the Related Art

A printing system where a plurality of image forming apparatuses such as a multifunction peripheral is connected to an information processing apparatus such as a personal computer (PC) and the plurality of image forming apparatuses performs print processing on print jobs generated by the information processing apparatus in a shared manner has been known.

Concerning such a printing system, a technique for registering the plurality of image forming apparatuses in a server as output devices, storing a print job transmitted from a terminal apparatus in the server, and causing an image forming apparatus to execute the print job stored in the server has been discussed (Japanese Patent Application Laid-Open No. 2005-165393).

Techniques by which a server converts a print job into a format printable by an image forming apparatus and transmits the converted print job to the image forming apparatus have also been discussed ((Request for Comments (RFC) 2911: https://tools.ietf.org/html/rfc2911), (Printer Working Group (PWG) 5100.13: Job and Printer Extensions, https://ftp.pwg.org/pub/pwg/candidates/cs-ippjobprinterext3v10-20120727-5100.13.pdf), (PWG: Internet Printing Protocol (IPP) Shared Infrastructure Extensions, ftp://ftp.pwg.org/pub/pwg/ipp/wd/wd-ippsix10-20140226.pdf), and (PWG: PWG Raster Format, ftp://ftp.pwg.org/pub/pwg/candidates/cs-ippraster10-20120420-5102.4.pdf)).

In addition, a technique for encrypting a print job itself for a terminal apparatus to transmit and thereby preventing illegal tapping and tampering of the print job stored in the cloud server by third parties has been discussed (PWG: IPP Document Encryption, http://ftp.pwg.org/pub/pwg/ipp/whitepaper/tb-doccrypt-20180205.pdf).

Suppose, for example, that in a printing system such as that discussed in Japanese Patent Application Laid-Open No. 2005-165393, the user operates an image forming apparatus and the image forming apparatus receives a print job stored in an information processing apparatus, such as a server, from the information processing apparatus and executes the print job. In such a case, the following issue can occur.

If, for example, some of the plurality of image forming apparatuses registered in the information processing apparatus support encrypted printing and some do not, an encrypted print job transmitted from the information processing apparatus by the user operation is not always executable. It may therefore be desirable for the user to check whether the image forming apparatus he/she intends to run the print job on can execute the print job, which is troublesome.

### SUMMARY

The present disclosure is directed to reducing a user's trouble when an image forming apparatus receives an encrypted print job stored in an information processing apparatus from the information processing apparatus and executes the print job based on the user's operations.

According to an aspect of the present disclosure, an information processing apparatus includes a registration unit configured to register a first image forming apparatus in a virtual printer, and a reception unit configured to receive capability information from the first image forming apparatus, wherein the capability information includes at least information indicating that the first image forming apparatus executes an encrypted print job, wherein the registration unit is configured not to register a second image forming apparatus corresponding to predetermined capability information received by the reception unit, and wherein the predetermined capability information does not include information that the second image forming apparatus executes the encrypted print job.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a printing system.

FIG. 2 is a diagram illustrating an example of a hardware configuration of a multifunction peripheral (MFP).

FIG. 3 is a diagram illustrating an example of a hardware configuration of a cloud server.

FIG. 4 is a diagram illustrating an example of a hardware configuration of a terminal apparatus.

FIG. 5 is a diagram illustrating an example of a software configuration of the MFP.

FIG. 6 is a diagram illustrating an example of a software configuration of the cloud server.

FIG. 7 is a diagram illustrating an example of a sequence in registering information about the MFP in a virtual printer.

FIG. 8 is a diagram illustrating an example of a setting screen for desirable conditions, displayed on an operation unit of the terminal apparatus.

FIG. 9 is a diagram illustrating an example of capability information about MFPs.

FIG. 10 is a diagram illustrating examples of messages in transmitting a printer registration request and a registration result notification in Internet Printing Protocol (IPP) communication between the cloud server and an MFP.

FIG. 11 is a diagram illustrating examples of a message in transmitting capability information about an MFP in the IPP communication between the cloud server and the MFP.

FIG. 12 is a diagram illustrating examples of a message of the registration result notification (Register-Output-Device-Response) that the cloud server transmits to an MFP in the IPP communication between the cloud server and the MFP.

FIG. 13 is a diagram illustrating examples of a participation registration screen displayed on the operation unit of an MFP.

FIG. 14 is a flowchart illustrating an example of processing in registering an MFP in the virtual printer.

FIG. 15 is a flowchart illustrating an example of processing when the cloud server registers an MFP.

FIG. 16 is a diagram illustrating an example of a sequence of print processing for transmitting a print job from a terminal apparatus to the cloud server and executing the print job by an MFP.

FIG. 17 is a diagram illustrating examples of a print setting screen displayed on the operation unit of a terminal apparatus.

### DESCRIPTION OF THE EMBODIMENTS

Exemplary embodiments of the present disclosure will be described below with reference to the drawings. The configurations described in the following exemplary embodiments are just examples, and the present disclosure is not limited to the illustrated configurations.

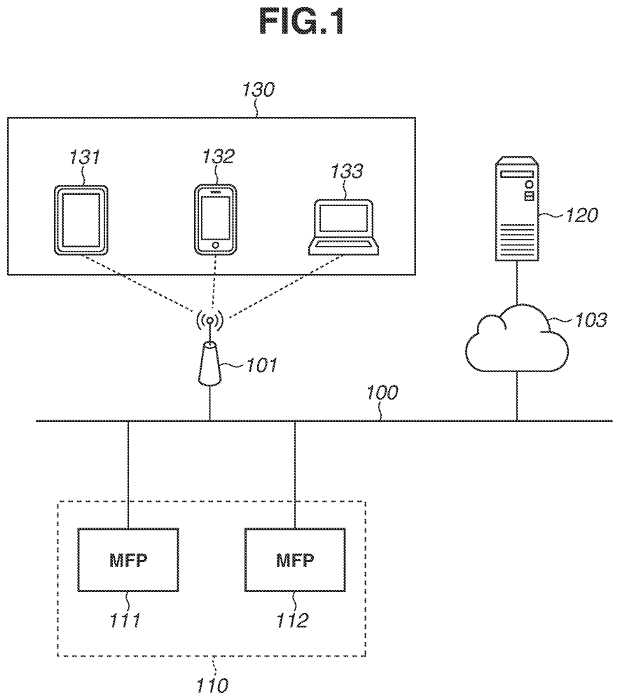

A first exemplary embodiment will be described below. FIG. 1 is a diagram illustrating an example of a configuration of a printing system. The printing system illustrated in FIG. 1 includes multifunction peripherals (MFPs) 111 and 112 that are examples of an image forming apparatus, terminal apparatuses 131, 132, and 133 that are examples of an external apparatus, and a cloud server 120 that is an example of an information processing apparatus and runs a virtual printer. The MFPs 111 and 112 may be referred to collectively as MFPs 110. Examples of the terminal devices 131, 132, and 133 include external apparatuses such as a tablet, a smartphone, and a personal computer (PC). The terminal apparatuses 131, 132, and 133 may be referred to collectively as terminal apparatuses 130.

The MFPs 110 and the terminal apparatuses 130 are connected to each other via an access point 101 connected to a local area network (LAN) 100. In the present exemplary embodiment, the terminal apparatuses 130 are connected to the LAN 100 by wireless communication. However, this is not restrictive. For example, the terminal apparatuses 130 may be connected to the LAN 100 by wired connection.

The LAN 100 to which the MFPs 110 and the terminal apparatuses 130 are connected is connected to the Internet 103. The MFPs 110 and the terminal apparatuses 130 can connect to the cloud server 120 via the Internet 103.

The MFPs 111 and 112 may have the same or different print processing capabilities.

While the present exemplary embodiment is described by using the foregoing configuration example as an example of the printing system, the configuration of the printing system is not limited thereto. At least one terminal apparatus and at least one MFP may be connected to the cloud server 120 via the LAN 100 and the Internet 103. The LAN 100 may be a wireless or wired network.

In the present printing system, print jobs are not directly transmitted from the terminal apparatuses 130 to the MFPs 110, but once transmitted to the cloud server 120 via the Internet 103 and stored in the cloud server 120. The MFPs 110 then request the print jobs in the cloud server 120 and execute the received print jobs. A print job refers to data including a command for causing an MFP 110 to perform print processing, image data, and print setting information.

While the present exemplary embodiment is described by using the foregoing configuration example as an example of the printing system, the present disclosure is not limited thereto. At least one information processing apparatus and at least one image forming apparatus may be communicably connected via a network. The network may be a wireless or wired one.

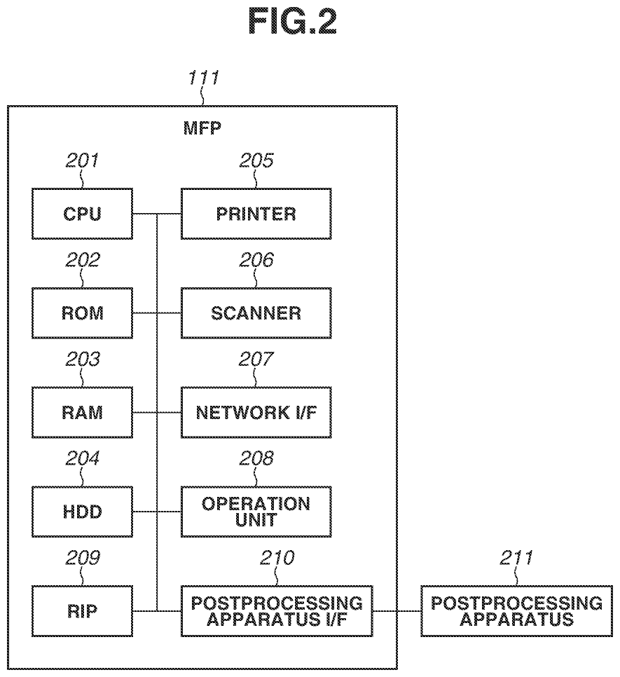

FIG. 2 is a diagram illustrating an example of a hardware configuration of the MFP 111. The MFP 111 includes a central processing unit (CPU) 201, a read-only memory (ROM) 202, a random access memory (RAM) 203, a hard disk drive (HDD) 204, a printer 205, a scanner 206, a network interface (I/F) 207, and an operation unit 208.

The MFP 111 also includes a raster image processor (RIP) 209 and a postprocessing apparatus I/F 210.

The CPU 201 controls the MFP 111 in a centralized manner. The CPU 201 transmits signals to various pieces of hardware via a bus line and performs mutual data communication with other pieces of hardware.

The ROM 202 stores programs and various types of data to be used by the CPU 201. The RAM 203 is a work memory for temporarily storing programs and data that the CPU 201 uses for calculation. The HDD 204 stores various types of data and various programs. While the MFP 111 according to the present exemplary embodiment is described to use the HDD 204 as an auxiliary storage device by way of example, a nonvolatile memory such as a solid state drive (SSD) may be used as the auxiliary storage device.

The printer 205 is a unit that implements a print function. The printer 205 performs processing for printing an image on a sheet based on image data included in a print job transmitted from a terminal apparatus 130 via the cloud server 120.

The scanner 206 is a unit that implements a scan function. The scanner 206 performs processing for optically reading a document and converting the read document into image data.

The CPU 201 of the MFP 111 controls operation of the MFP 111 based on control programs in the MFP 111. More specifically, the CPU 201 executes an operating system (OS) for controlling the MFP 111 and driver programs for controlling hardware I/Fs. Application programs on the OS operate with each other to activate and control user-desired functions. The OS and various programs are stored in the ROM 202, and read from the ROM 202 into the RAM 203 for execution.

The network I/F 207 of the MFP 111 may be a wired connection LAN_I/F. A Universal Serial Bus (USB)-LAN adaptor may be used for connection. Alternatively, the network I/F 207 may be a wireless connection LAN_I/F.

The network I/F 207 of the MFP 111 is connected to the cloud server 120 via the LAN 100 and the Internet 103.

The operation unit 208 is a user interface for the user using the MFP 111 to use the printer 205 and the scanner 206. For example, the operation unit 208 is a touch panel for accepting operations and inputs. The operation unit 208 may also be used as a display unit that displays information about the MFP 111. An external operation device and/or an external display device may be connected to the MFP 111 according to the present exemplary embodiment.

The RIP 209 is a hardware module for performing rasterization processing for rendering a page description language (PDL) into a raster image. In the present exemplary embodiment, the RIP 209 is described to be a built-in hardware module by way of example. However, the RIP 209 may be stored in the ROM 202 as a software module.

The hardware configuration of the MFP 111 has been described with reference to FIG. 2, and the MFP 112 may have a similar hardware configuration to that of the MFP 111. As long as the MFP 112 is a predetermined image forming apparatus capable of Internet Printing Protocol (IPP) communication, the MFP 112 may include a CPU and/or RAM of different performance or may have a different printable sheet size. The IPP is an example of a printing protocol.

In the MFP 111 according to the present exemplary embodiment, one CPU 201 performs various types of processing illustrated in a flowchart to be described below by using one memory (RAM 203). However, other configurations may be employed. For example, a plurality of CPUs, RAMs, ROMs, and storages may cooperate to perform the various types of processing illustrated in the flowchart to be described below. Part of the processing may be performed by using a hardware circuit such as an application specific integrated circuit (ASIC) and a field-programmable gate array (FPGA).

The postprocessing apparatus I/F 210 connects the MFP 111 to a postprocessing apparatus 211. The postprocessing apparatus 211 receives control commands indicating instructions such as punching and stapling instructions from the CPU 201, and based on the control commands, performs postprocessing on a sheet on which an image is printed by the printer 205.

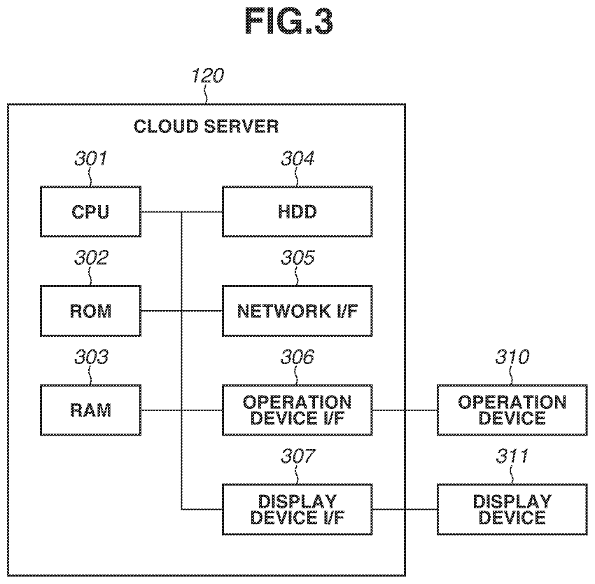

FIG. 3 is a diagram illustrating an example of a hardware configuration of the cloud server 120.

The virtual printer (cloud server) 120 includes a CPU 301, a ROM 302, a RAM 303, an HDD 304, a network I/F 305, an operation device I/F 306, and a display device I/F 307.

The CPU 301 controls the cloud server 120 in a centralized manner. The CPU 301 transmits signals to various pieces of hardware via a bus line and performs mutual data communication with other pieces of hardware.

The ROM 302 stores programs and various types of data to be used by the CPU 301. The RAM 303 is a work memory for temporarily storing programs and data that the CPU 301 uses for calculation. The HDD 304 stores various types of data and various programs. While the cloud server 120 according to the present exemplary embodiment is described to use the HDD 304 as an auxiliary storage device by way of example, a nonvolatile memory such as an SSD may be used as the auxiliary storage device.

The network I/F 305 may be a wired connection LAN_I/F. A USB-LAN adaptor may be used for connection. Alternatively, the network I/F 305 may be a wireless connection LAN_I/F.

The network I/F 305 is connected to the MFPs 110 and the terminal apparatuses 130 via the LAN 100 and the Internet 103.

The operation device I/F 306 is an I/F for connecting the cloud server 120 to an operation device 310 such as a keyboard and a mouse.

The display device I/F 307 is an I/F for connecting the cloud server 120 to a display device 311 such as a display.

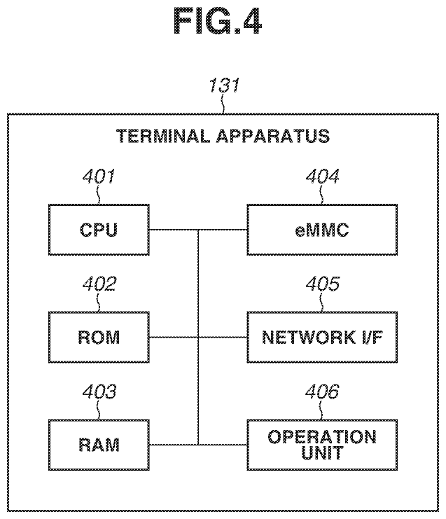

FIG. 4 is a diagram illustrating an example of a hardware configuration of the terminal apparatus 131. The terminal apparatus 131 includes a CPU 401, a ROM 402, a RAM 403, an embedded MultiMedia Card (eMMC) 404, a network I/F 405, and an operation unit 406.

The CPU 401 controls the terminal apparatus 131 in a centralized manner. The CPU 401 transmits signals to various pieces of hardware via a bus line and performs mutual data communication with other pieces of hardware.

The ROM 402 stores programs and various types of data to be used by the CPU 401. The RAM 403 is a work memory for temporarily storing programs and data that the CPU 401 uses for calculation. The eMMC 404 stores various types of data and various programs.

The network I/F 405 may be a wired connection LAN_I/F. A USB-LAN adaptor may be used for connection. Alternatively, the network IF 405 may be a wireless connection LAN_I/F.

The network I/F 405 is connected to the cloud server 120 via the LAN 100 and the Internet 103.

The operation unit 406 is a user interface for a user to use the terminal apparatus 131. For example, the operation unit 406 is a touch panel for accepting operations and inputs from the user. The operation unit 406 can also be used as a display unit that displays information about the terminal apparatus 131. An external operation device and/or an external display device may be connected to the terminal apparatus 131 according to the present exemplary embodiment.

The hardware configuration of the terminal apparatus 131 has been described with reference to FIG. 4. The terminal apparatuses 132 and 133 may have a similar hardware configuration to that of the terminal apparatus 131. As long as the terminal apparatuses 132 and 133 is capable of IPP communication, the rest of the configuration may be different.

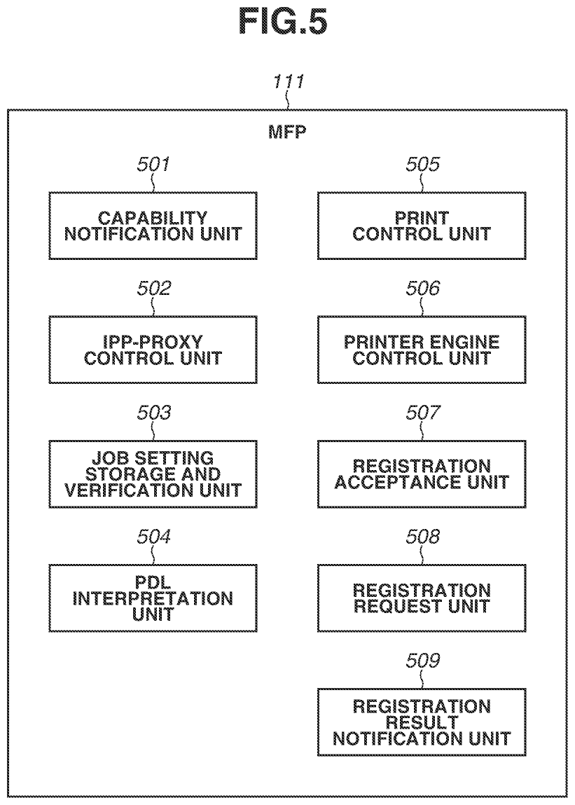

FIG. 5 is a diagram illustrating an example of a software configuration of the MFP 111. The CPU 201 runs a capability notification unit 501 to transmit capability information about the MFP 111 to the cloud server 120. Examples of the capability information include the following: “copies-supported” indicating whether the number of copies can be handled; “document-format-supported” indicating a supported format or formats; and “feed-orientation-supported” indicating information about an optimum feed direction.

The CPU 201 of the MFP 111 runs an IPP-proxy control unit 502 to receive data such as a print job from the cloud server 120 via IPP communication.

The CPU 201 runs a job setting storage and verification unit 503 to verify attributes of the received print job and store the verified attributes in the RAM 203. Specifically, the CPU 201 checks print settings included in the print job and stores the print settings in the RAM 203. For example, the CPU 201 checks and stores the number of copies to be printed, executable finishing processing, and PDL format information.

The CPU 201 runs a PDL interpretation unit 504 to interpret drawing data included in the received print job. The CPU 201 also controls the RIP 209 to perform the rasterization processing. The PDL interpretation unit 504 according to the present exemplary embodiment supports a Printer Working Group (PWG) Raster format.

The CPU 201 runs a print control unit 505 to separate the rasterized image data into red, blue, and green (RGB) image data.

The CPU 201 runs a printer engine control unit 506 to control the printer 205 for page-by-page print processing based on the color-separated RGB image data and the print settings.

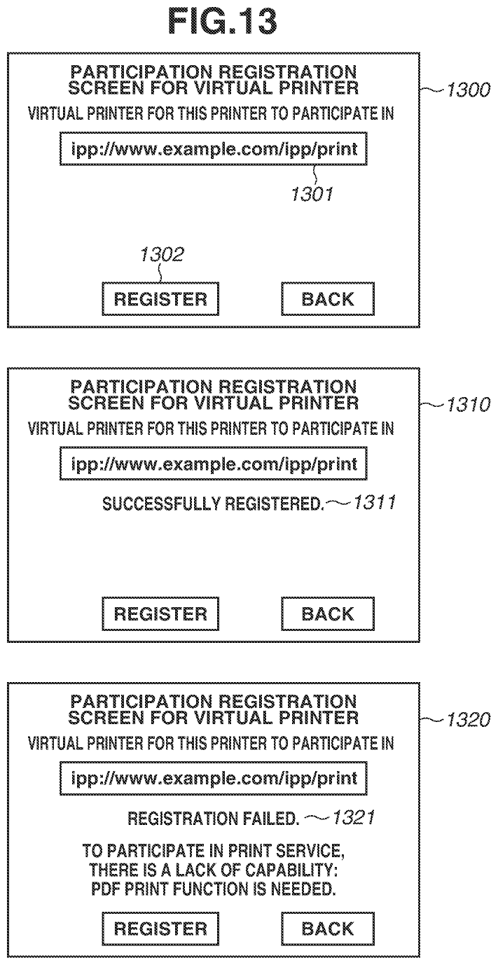

The CPU 201 runs a registration acceptance unit 507 to display a screen for registering a virtual printer in which the MFP 111 is to be registered on the operation unit 208. FIG. 13 illustrates a participation registration screen 1300 that is an example of the screen. Details of the participation registration screen 1300 will be described below.

The CPU 201 runs a registration request unit 508 to transmit a registration request (Register-Output-Device-Request) to the virtual printer registered via the participation registration screen 1300.

The CPU 201 runs a registration result notification unit 509 to display a registration result on a screen on the operation unit 208 based on information indicating the registration result transmitted from the virtual printer to which the registration request is transmitted. Examples of the screen displayed here include participation registration screens 1310 and 1320.

Suppose, for example, that in a printing system such as that discussed in Japanese Patent Application Laid-Open No. 2005-165393, the user operates an image forming apparatus and the image forming apparatus receives a print job stored in an information processing apparatus, such as a server, from the information processing apparatus and executes the print job. In such a case, the following issue can occur.

If, for example, some of a plurality of image forming apparatuses registered in the information processing apparatus support encrypted printing and some do not, an encrypted print job transmitted from the information processing apparatus by the user is not always executable. It may therefore be desirable for the user to check whether the image forming apparatus he/she intends to run the print job on can execute the print job, which is troublesome.

To address such an issue, when an image forming apparatus receives an encrypted print job stored in the information processing apparatus from the information processing apparatus and executes the print job based on the user's operations, the user's trouble can be reduced by the execution of processing described below.

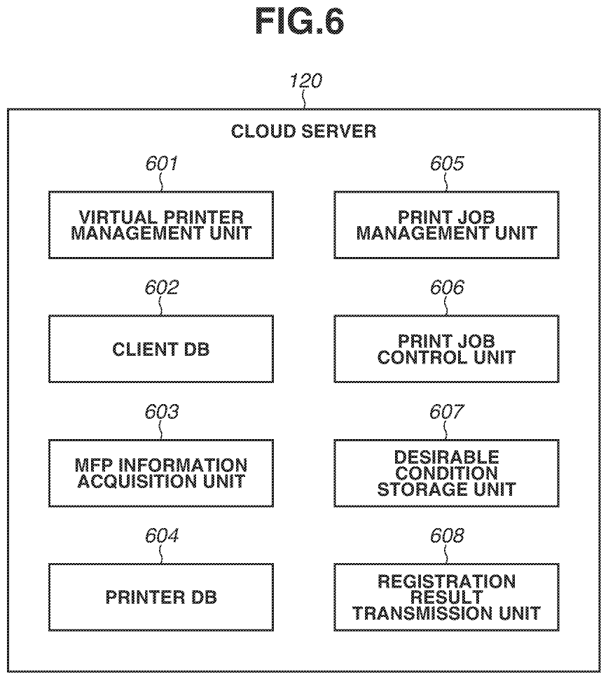

FIG. 6 is a diagram illustrating an example of a software configuration of the cloud server 120.

The CPU 301 runs a virtual printer management unit 601 to store client information received by IPP communication into a client database (DB) 602 in the HDD 304. Examples of the client information includes Internet Protocol (IP) addresses and port numbers of the terminal apparatuses 130.

The CPU 301 runs an MFP information acquisition unit 603 to receive MFP information from the MFPs 110 by IPP communication and store the MFP information in a printer DB 604 in the HDD 304. The MFP information includes identifiers of the MFPs 110, capability information about the MFPs 110, and names of the MFPs 110. Here, an identifier of the virtual printer may also be stored in association with the MFP information.

The CPU 301 runs a print job management unit 605 to store print jobs received from the terminal apparatuses 130 into a predetermined area of the HDD 304. Here, the CPU 301 stores the identifier of the virtual printer selected by the users from the terminal apparatuses 130 and identifiers of the print jobs into the HDD 304 in association with each other.

The CPU 301 runs a print job control unit 606 to transmit a print job stored in the predetermined area of the HDD 304 to an MFP 110 if a request for the print job is received from the MFP 110 by IPP communication.

The CPU 301 runs a desirable condition storage unit 607 to store capability information that is desirable conditions received from the terminal apparatuses 130 into the HDD 304.

The CPU 301 runs a registration result transmission unit 608 to transmit the result of a comparison made between the capability information that is the desirable conditions and received capability information to the MFPs 110.

In a conventional printing system, as discussed in PWG “IPP Shared Infrastructure Extensions” ftp://ftp.pwg.org/pub/pwg/ipp/wd/wd-ippsix10-20140226.pdf, an image forming apparatus not supporting PDF can execute a PDF print job if an information processing apparatus, such as a server, converts the format of the PDF print job.

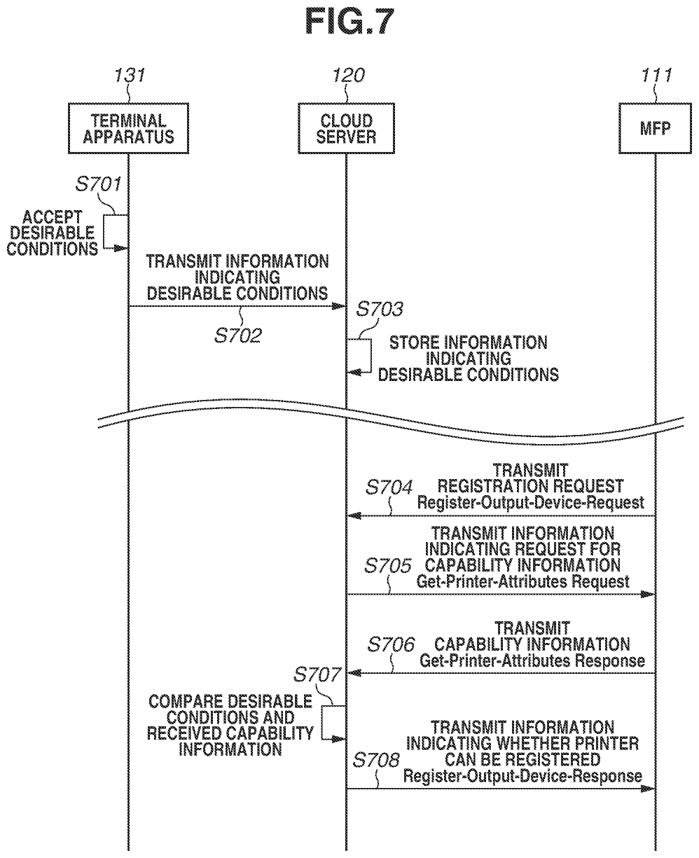

FIG. 7 is a diagram illustrating an example of a sequence in registering information about the MFP 111 in the virtual printer. The sequence is started when the user operates the terminal apparatus 131 and the cloud server 120 receives a setting instruction for a printer registration condition. The sequence is implemented by IPP communication between the apparatuses.

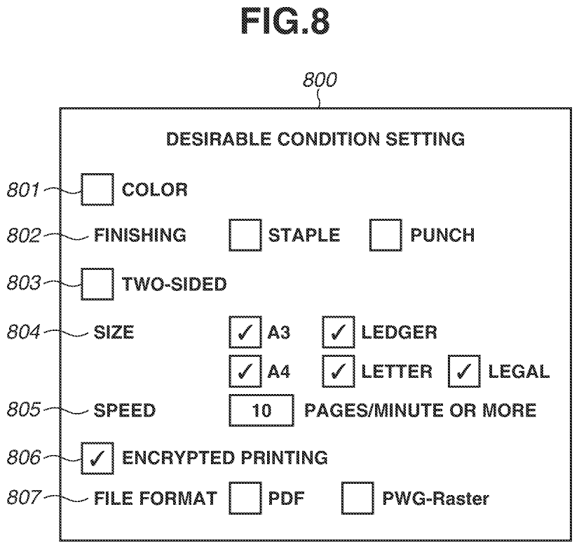

In step S701, the CPU 401 of the terminal apparatus 131 accepts desirable conditions for registering an MFP in the virtual printer by accepting the user's operations on a setting screen 800 illustrated in FIG. 8. The desirable conditions are information indicating minimum capabilities that an MFP to be registered in the virtual printer needs to satisfy.

In step S702, the CPU 401 of the terminal apparatus 131 transmits information indicating the desirable conditions for printer registration specified by the user to the cloud server 120.

In step S703, the CPU 301 of the cloud server 120 stores the received information indicating the desirable conditions into the HDD 304.

In step S704, the user gives an instruction for registration on the participation registration screen 1300 displayed on the operation unit 208. The CPU 201 of the MFP 111 transmits a printer registration request (Register-Output-Device-Request) to the cloud server 120. Details of the participation registration screen 1300 illustrated in FIG. 13 will be described below.

In step S705, the CPU 301 of the virtual printer (cloud server 120) transmits information (Get-Printer-Attributes Request) indicating a request for capability information about the MFP 111 to the MFP 111 transmitting the participation registration request. Capability information is information indicating functions supported by an MFP 110. Examples of the information indicating the functions (capabilities) supported by an MFP 110 include “executability of two-sided printing”, “supported sheet sizes”, “postprocessing capabilities”, “encrypted printing”, and “file formats”.

In step S706, the CPU 201 of the MFP 111 receiving the information indicating a request for capability information transmits the capability information about the MFP 111 to the cloud server 120 as a response (Get-Printer-Attributes Response). In the present exemplary embodiment, the MFPs 110 transmit their capability information to the cloud server 120 in response to receipt of a request for capability information from the cloud server 120. However, this is not restrictive. For example, the MFPs 110 may transmit the capability information to the virtual printer together with the registration request. In such a case, the cloud server 120 may perform the following processing on the capability information received with the registration request without transmitting the request for capability information.

In step S707, the CPU 301 of the cloud server 120 compares the desirable conditions (capability information) stored in step S703 and the capability information about the MFP 111 received in step S706. Here, the CPU 301 determines whether the capability information that is the desirable conditions is included in the received capability information. For example, if the capability information that is the desirable conditions includes “A4” and “two-sided printing supported” and the received capability information includes “A4, A3” and “two-sided printing supported”, the CPU 301 determines that the capability information that is the desirable conditions is included in the received capability information.

In step S708, the CPU 301 of the cloud server 120 transmits information (Register-Output-Device-Response) indicating whether a printer can be registered to the MFP 111 based on the result of the comparison made in step S707. If, in step S707, the capability information that is the desirable conditions is determined to be included in the received capability information, then in step S708, the CPU 301 registers the MFP 111 as a printer participating in the virtual printer, and transmits information indicating that the printer can be registered to the MFP 111. If, in step S707, the capability information that is the desirable conditions is determined to be not included in the received capability information, then in step S708, the CPU 301 transmits information indicating that the printer is not registrable to the MFP 111.

FIG. 8 is a diagram illustrating an example of the setting screen 800 for the desirable conditions, displayed on the operation unit 406 of the terminal apparatus 131.

The setting screen 800 is a screen for setting conditions on the capabilities of the MFP 111 to be registered in the virtual printer.

A color item 801 is an item for setting whether the MFP to be registered in the virtual printer needs to support color printing. If the checkbox is checked, only MFPs supporting color printing can be registered in the virtual printer.

A finishing item 802 is an item for setting whether the MFP to be registered in the virtual printer needs to support postprocessing capabilities “staple” and “punch”. If the staple checkbox is checked, only MFPs supporting stapling can be registered in the virtual printer. If the punch checkbox is checked, only MFPs supporting punching can be registered in the virtual printer.

A two-sided item 803 is an item for setting whether the MFP to be registered in the virtual printer needs to support two-sided printing. If the checkbox is checked, only MFPs supporting two-sided printing can be registered in the virtual printer.

A size item 804 is an item for setting whether the MFP to be registered in the virtual printer needs to support sizes such as A3, A4, and LETTER. If the checkbox of each size is checked, only MFPs supporting that size can be registered in the virtual printer. In FIG. 8, the checkboxes of all the sizes A3, LEDGER, A4, LETTER, and LEGAL are selected. This indicates that the MFPs 110 to be registered in the virtual printer desirably support all the sheet sizes A3, LEDGER, A4, LETTER, and LEGAL.

A speed item 805 is an item for setting whether the MFP needs to be registered in the virtual printer to support the user-specified printing speed. Only MFPs capable of printing at a printing speed higher than or equal to the input numerical value can be registered in the virtual printer.

An encrypted printing item 806 is an item for setting whether the MFP to be registered in the virtual printer needs to support printing of encrypted print data. If the checkbox is checked, only MFPs that can decrypt encrypted print data and print the decrypted print data by input of a password or by identification (ID) card authentication can be registered in the virtual printer.

A file format item 807 is an item for setting whether the MFP to be registered in the virtual printer needs to support file formats such as PDF and PWG-Raster formats. If the checkbox of a file format is checked, only MFPs supporting the file format can be registered in the virtual printer. Neither of the PDF and PWG-Raster items on the setting screen 800 necessarily needs to be selected. The settings made on the setting screen 800 are stored in the HDD 304.

The cloud server (virtual printer) 120 according to the present exemplary embodiment can convert a PDF file into a PWG-Raster file. An MFP supporting only the PWG-Raster format can therefore be registered in the same virtual printer as MFPs supporting both the PDF and PWG-Raster formats without issue. However, the cloud server (virtual printer) 120 according to the present exemplary embodiment is unable to convert an encrypted PDF file into a PWG-Raster file.

The setting screen 800 may be displayed on the display device 311 connected to the cloud server 120, and settings may be accepted via the operation device 310 connected to the cloud server 120.

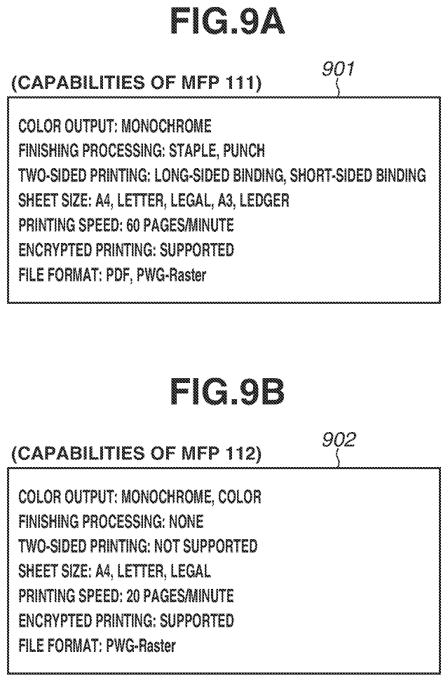

FIG. 9 is a diagram illustrating examples of the capability information about the MFPs 110. Capability information 901 represents the capability information about the MFP 111. The capability information 901 indicates the functions supported by the MFP 111. The capabilities of the MFP 111 include only “monochrome” printing for color output, “staple, punch” for finishing processing, and “long-edge binding, short-edge binding” for two-sided printing. The capability information 901 also indicates that supported sheet sizes are “A4, LETTER, LEGAL, A3, LEDGER”, and the supported printing speed is 60 pages/minute. The capability information 901 further indicates that encrypted printing is supported, and supported file formats are the PDF and PWG-Raster formats.

Capability information 902 represents the capability information about the MFP 112. The capabilities of the MFP 112 include “monochrome, color” for color output, “none” for finishing processing, and “not supported” for two-sided printing, and “A4, LETTER, LEGAL” for supported sheet sizes. The capability information 902 also indicates that the printing speed is 20 pages/minutes. The capability information 902 further indicates that encrypted printing is supported, and the only supported file format is the PWG-Raster format (PDF is not supported).

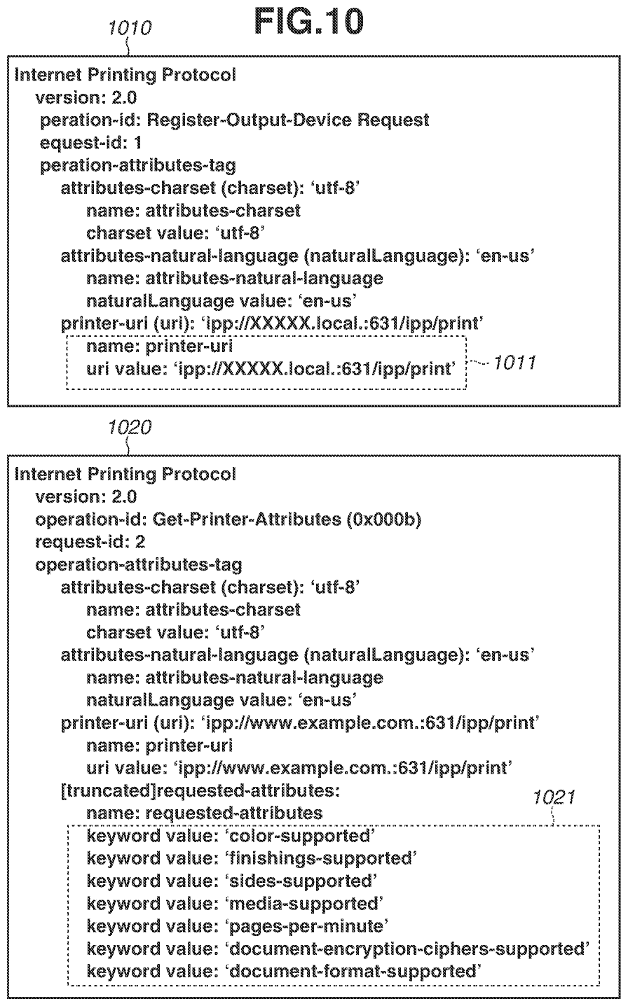

FIGS. 10 to 12 illustrate examples of IPP communication messages exchanged between the MFPs 110 and the cloud server 120.

FIG. 10 is a diagram illustrating examples of the messages in transmitting a printer registration request and a registration result notification in IPP communication between the cloud server 120 and an MFP 110.

A message 1010 is an example of the message transmitted when the MFP 110 transmits a registration request (Register-Output-Device-Request) to the cloud server 120. The message 1010 corresponds to the printer registration request transmitted in step S704. A message includes header information about the Hypertext Transfer Protocol (HTTP) layer and IPP message data on the HTTP layer.

IPP message data 1011 includes “ipp://XXXXX.local.:631/ipp/printer” that indicates the identifier of the MFP 110. The cloud server 120 transmits a request for capability information and a registration result notification to the MFP 110 that applies to the identifier in the IPP message data 1011.

A message 1020 is an example of the message transmitted when the cloud server 120 issues a request for capability information (Get-Printer-Attributes Request) to an MFP 110. The message 1020 corresponds to the request transmitted in step S705.

IPP message data 1021 indicates the types of capability information to request from the MFP 110. “Keyword value: ‘color-supported’” is a keyword for requesting the availability of color printing, and “keyword value: ‘finishings-supported’” the presence or absence of finishing processing supported. “Keyword value: ‘sides-supported’” is a keyword for requesting the presence or absence of two-sided printing support, and “keyword value: ‘media-supported’” the types of supported sheet types. “Keyword value: ‘pages-per-minute’” is a keyword for requesting the printing speed (pages/minutes). “Keyword value: ‘document-encryption-ciphers-supported’” is a keyword for requesting the presence or absence of encrypted printing support. “Keyword value: ‘document-format-supported’” is a keyword for requesting the types of supported file formats.

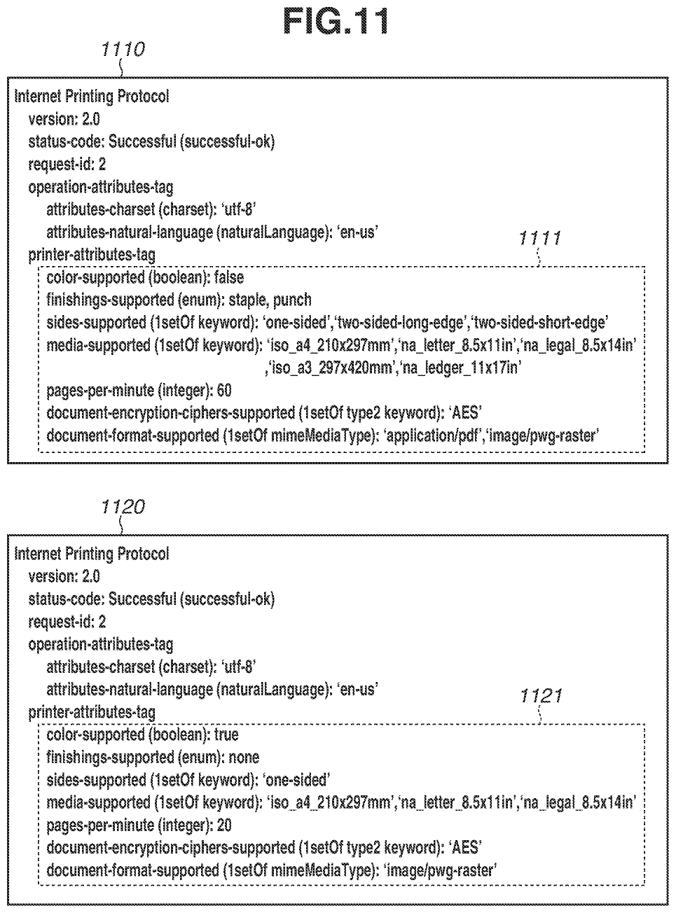

FIG. 11 is a diagram illustrating examples of the message in transmitting the capability information about an MFP 110 in IPP communication between the cloud server 120 and the MFP 110.

A message 1110 is an example of the message transmitted when the MFP 111 transmits capability information (Get-Printer-Attributes Response) to the cloud server 120 as a response. The message 1110 applies to the capability information transmitted in step S706.

IPP message data 1111 in the message 1110 indicates the capability information about the MFP 111. “Color-supported (Boolean): false” indicates that only monochrome printing is available. “Finishings-supported (enum): staple, punch” indicates that stapling and punching are available as finishing processing. “Sides-supported (1setOf keyword): ‘one-sided’,‘two-sided-long-edge’, ‘two-sided-short-edge’” indicates that long-edge binding and short-edge binding are available in two-sided printing. “Media-supported (1 setOf keyword): ‘iso_a4_210×297 mm’,‘na_letter_8.5×11in’,‘iso_a3_297×420 mm’,‘na_ledger_11×17in’” indicates that the supported sheet sizes are A4, LETTER, A3, and LEDGER. “Pages-per-minute (integer): 60” indicates that the printing speed is 60 pages/minute.

“Document-encryption-ciphers-supported (1setOf type2 keyword): ‘AES’” indicates that encrypted printing is supported. Advanced Encryption Standard (AES) is a typical encryption method of common key scheme. If other encryption schemes (such as Data Encryption Standard (DES) and Triple DES (3DES)) are supported, the plurality of schemes may be enumerated. “Document-format-supported (1setOf mimeMediaType): ‘application/pdf’,‘image/pwg-raster’” indicates that both the PDF and PWG-Raster formats are supported.

A message 1120 is an example of the message transmitted when the MFP 112 transmits capability information (Get-Printer-Attributes Response) to the cloud server 120 as a response. The message 1120 applies to the capability information transmitted in step S706.

IPP message data 1121 in the message 1120 indicates the capability information about the MFP 112. “Color-supported (Boolean): true” indicates that both monochrome printing and color printing are available. “Finishings-supported (enum): none” indicates that no finishing processing is available. “Sides-supported (1setOfkeyword): ‘one-sided’” indicates that two-sided printing is not available.

“Media-supported (1setOf keyword): ‘iso_a4_210×297 mm’,‘na_letter_8.5×11in’,‘na_legal_8.5×14in’” indicates that the supported sheet sizes are A4, LETTER, and LEGAL.

“Pages-per-minute (integer): 20” indicates that the printing speed is 20 pages/minute. “Document-encryption-ciphers-supported (1setOf type2 keyword): ‘AES’” indicates that encrypted printing is supported. “Document-format-supported (1setOf mimeMediaType): ‘image/pwg-raster’” indicates that the supported file format is the PWG-Raster format.

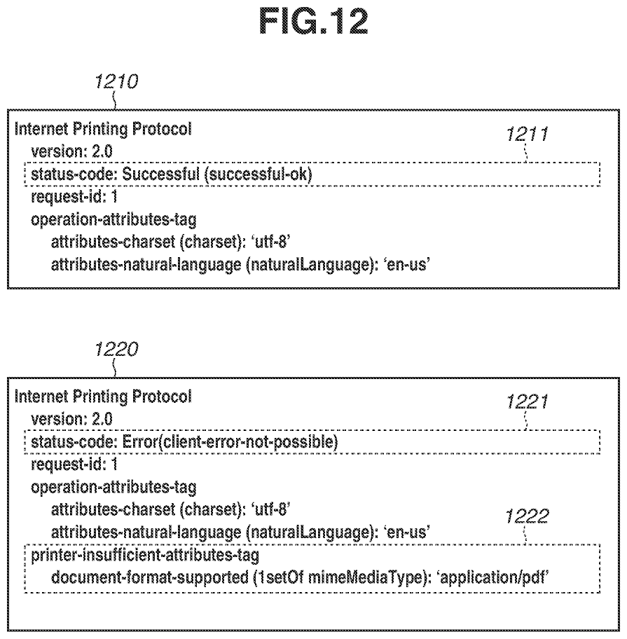

FIG. 12 is a diagram illustrating examples of the message of the registration result notification (Register-Output-Device-Response) that the cloud server 120 transmits to an MFP 110 in IPP communication between the cloud server 120 and the MFP 110. This message corresponds to the information indicating that the printer can be registered, which is transmitted in the processing of step S708.

A message 1210 is an example of the message of the registration result notification (Register-Output-Device-Response) that the cloud server 120 transmits to an MFP 110.

IPP message data 1211 “status-code: Successful (successful-ok)” in the message 1210 indicates that the cloud server 120 has registered the MFP 110 as one of the printers of the cloud server 120.

A message 1220 is an example of the message of the registration result notification (Register-Output-Device-Response) that the cloud server 120 transmits to an MFP 110. The message 1220 corresponds to the information indicating that the printer is not registrable, transmitted in the processing of step S708.

IPP message data 1221 “status-code: Error (client-error-not-possible)” indicates that the cloud server 120 has not registered the MFP 110 as one of the printers of the virtual printer.

The IPP message data 1222 further indicates a capability insufficient for the cloud server 120 to register the MFP 110 as one of the printers of the virtual printer. In other words, the IPP message data 1222 indicates the lacking capability compared to the capabilities that are the desirable conditions set in the virtual printer. “Document-format-supported (1setOf mimeMediaType): ‘application/pdf’” indicates that the MFP 110 has failed to be registered as one of the printers of the virtual printer because PDF is not supported.

FIG. 13 is a diagram illustrating examples of the participation registration screen displayed on the operation unit 208 of the MFP 111.

The participation registration screen 1300 is a screen for the user to register a virtual printer in which the MFP 111 participates via the operation unit 208. The participation registration screen 1300 is displayed when the CPU 201 executes the processing of step S704.

An input field 1301 accepts the user's operations. Here, a Universal Resource Locator (URL) “ipp://www.example.com/ipp/print” that is the identifier of the virtual printer in which the MFP 111 participates is input in the input field 1301. The user may directly input the identifier to the input field 1301 by operating a software keyboard. Identifies input in the past may be stored as a history, and one of the identifiers may be selected from the history for input. The identifier input to the input field 1301 is not limited to a URL. For example, a Universal Resource Identifier (URI), an IP address, or a multimedia access control (MAC) address may be used.

If a registration button 1302 is selected by the user, the MFP 111 transmits a printer registration request to the cloud server 120 based on the identifier (URL) input in the input field 1301. This processing corresponds to the processing of step S704.

The participation registration screen 1310 is a screen displayed if the registration button 1302 is selected by the user and the MFP 111 transmits a registration request to the cloud server 120 and receives information indicating that the MFP 111 can be registered (is registered) in the virtual printer from the cloud server 120.

A comment 1311 is text displayed if the MFP 111 receives the information that the MFP 111 can be registered (is registered) in the virtual printer from the cloud server 120.

The participation registration screen 1320 is a screen displayed if the registration button 1302 is selected by the user and the MFP 111 transmits a registration request to the cloud server 120 and receives information indicating that the MFP 111 is not registrable (not registered) in the virtual printer.

A comment 1321 is text displayed if the MFP 111 receives the information indicating that the MFP 111 is not registrable (not registered) in the virtual printer from the cloud server 120. The comment 1321 displays the failure of the registration in the virtual printer and the cause of the failure, i.e., that the MFP 111 lacks the PDF print function.

Only the administrator user of the MFP 111 may display the participation registration screen 1300 and give a participation instruction to the cloud server 120.

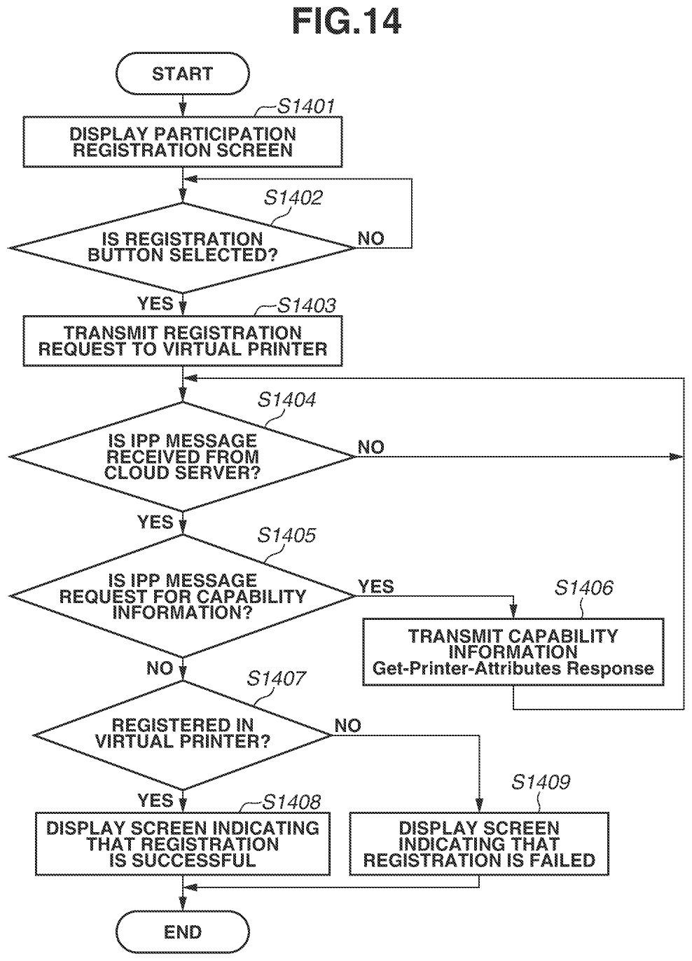

FIG. 14 is a flowchart illustrating an example of processing in registering the MFP 111 in the virtual printer. The processing of the flowchart illustrated in FIG. 14 is implemented by the CPU 201 reading a program stored in the ROM 202 into the RAM 203 and executing the program. The processing in the flowchart illustrated in FIG. 14 is started if an instruction to display the participation registration screen 1300 on the operation unit 208 is accepted from the user.

In step S1401, the CPU 201 displays the participation registration screen 1300 on the operation unit 208.

In step S1402, the CPU 201 determines whether the registration button 1302 is selected by the user via the operation unit 208. If the CPU 201 determines that the registration button 1302 is selected (YES in step S1402), the processing proceeds to step S1403. If the CPU 201 determines that the registration button 1302 is not selected (NO in step S1402), the processing returns to step S1402.

In step S1403, the CPU 201 transmits a registration request (Register-Output-Device-Request) to a virtual printer based on the identifier (URL) input to the input field 1301 of the participation registration screen 1300. For the sake of convenience, an example where the registration request is transmitted to the virtual printer on the cloud server 120 will be described here.

In step S1404, the CPU 201 determines whether an IPP message is received from the cloud server 120. If the CPU 201 determines that an IPP message is received (YES in step S1404), the processing proceeds to step S1405. If the CPU 201 determines that no IPP message is received (NO in step S1404), the processing returns to step S1404.

In step S1405, the CPU 201 determines whether the IPP message received in step S1404 is a request for capability information (Get-Printer-Attributes Request). If the IPP message is a request for capability information (YES in step S1405), the processing proceeds to step S1406. If the IPP message is not a request for capability information but a registration result notification (Register-Output-Device-Response) (NO in step S1405), the processing proceeds to step S1407.

In step S1406, the CPU 201 transmits the capability information (Get-Printer-Attributes Response) indicating the capabilities of the MFP 111 as a response to the request for capability information received from the cloud server 120. The IPP message transmitted from the MFP 111 here is the message 1110.

In step S1407, the CPU 201 interprets the IPP message that is the received registration result notification, and determines whether the MFP 111 is registered in the virtual printer. Specifically, if the received registration result notification is one like the message 1210 indicating that MFP 111 is registered, the CPU 201 determines that the MFP 111 is registered. If the received registration result notification is one like the message 1220 indicating that the MFP 111 is not registered, the CPU 201 determines that the MFP 111 is not registered. If the CPU 201 determines that the MFP 111 is registered (YES in step S1407), the processing proceeds to step S1408. If the CPU 201 determines that the MFP 111 is not registered (NO in step S1407), the processing proceeds to step S1409.

In step S1408, the CPU 201 displays a screen indicating that the registration is successful on the operation unit 208. The screen displayed here is one like the participation registration screen 1310. If the registration is successful, the CPU 201 stores the identifier of the virtual printer in the HDD 204.

In step S1409, the CPU 201 displays a screen indicating that the registration is failed on the operation unit 208. The screen displayed here is one like the participation registration screen 1320.

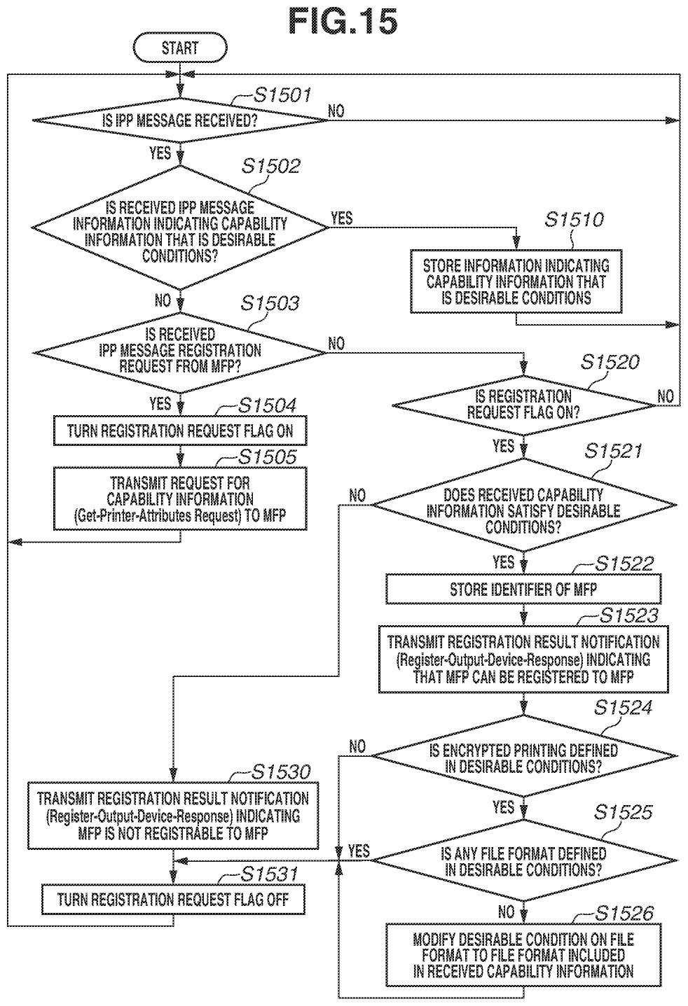

FIG. 15 is a flowchart illustrating an example of processing when the cloud server 120 registers an MFP 110. The processing of the flowchart illustrated in FIG. 15 is implemented by the CPU 301 reading a program stored in the ROM 302 into the RAM 303 and executing the program. The program to be read by the CPU 301 into the RAM 303 may be stored in a storage device such as the HDD 304. The processing in the flowchart illustrated in FIG. 15 is started by power-on of the cloud server 120.

In step S1501, the CPU 301 determines whether an IPP message is received. If the CPU 301 determines that an PP message is received (YES in step S1501), the processing proceeds to step S1502. If the CPU 301 determines that no IPP message is received (NO in step S1501), the processing returns to step S1501.

In step S1502, the CPU 301 determines whether the received IPP message is information indicating capability information that is desirable conditions received from a terminal apparatus 130. If the IPP message is information indicating capability information that is desirable conditions (YES in step S1502), the processing proceeds to step S1510. If the IPP message is not information indicating capability information that is desirable conditions (NO in step S1502), the processing proceeds to step S1503.

In step S1510, the CPU 301 stores the information indicating the capability information that is the desirable conditions, received from the terminal apparatus 130, into the HDD 304.

In step S1503, the CPU 301 determines whether the received IPP message is a registration request (Register-Output-Device-Request) received from an MFP 110. If the PP message is a registration request (YES in step S1503), the processing proceeds to step S1504. If the IPP message is not a registration request (NO in step S1503), the processing proceeds to step S1520.

In step S1504, the CPU 301 turns on a registration request flag indicating that an MFP 110 is requesting registration. Specifically, the CPU 301 stores information indicating that registration is being requested in the RAM 303.

In step S1505, the CPU 301 transmits a request for capability information (Get-Printer-Attributes Request) to the MFP 110 transmitting the IPP message.

Now, the case where the IPP message is determined to be not a registration request received from an MFP 110, i.e., to be capability information (Get-Printer-Attributes Response) received from the MFP 110 in step S1503 (NO in step S1503) will be described.

In step S1520, the CPU 301 determines whether the registration request flag is on. If the registration request flag is determined to be on (YES in step S1520), the processing proceeds to step S1521. If the registration request flag is determined to not be on (NO in step S1520), the processing returns to step S1501.

In step S1521, the CPU 301 compares the received capability information (Get-Printer-Attributes Response) and the capability information that is the desirable conditions, stored in the HDD 304, to determine whether the received capability information satisfies the desirable conditions. If the received capability information is determined to satisfy the desirable conditions (YES in step S1521), the processing proceeds to step S1522. If the received capability information is determined to not satisfy the desirable conditions (NO in step S1521), the processing proceeds to step S1530. Here, if the received capability information does not satisfy the capability information that is the desirable condition on the file format, the MFP 110 transmitting the capability information may be registered in the virtual printer. The reason is that the cloud server 120 can convert an unencrypted PDF print job received from the terminal apparatus 131 into the PWG-Raster format. For example, if PDF is set in the file format item 807 as capability information that is the desirable condition and the cloud server 120 receives a registration request from an MFP 110 that supports only the PWG-Raster format, the cloud server 120 permits the registration. By such processing, image forming apparatuses that do not satisfy the desirable condition but can execute a print job transmitted from a terminal apparatus through the use of format conversion can be registered in the virtual printer.

In step S1522, the CPU 301 stores the identifier of the MFP 110 transmitting the capability information (Get-Printer-Attributes Response) into the RAM 303. Storing the identifier includes registering the MFP 110 in the virtual printer. The identifier may be stored in a nonvolatile area such as the HDD 304. The identifier of the MFP 110 may be one indicated by the IPP message data 1011 or the IP address or MAC address of the MFP 110. Storing the identifiers of the MFPs 110 and determining whether access is made from an MFP 110 having one of the identifiers allows only the MFPs 110 registered in the virtual printer to execute print jobs stored in the HDD 304 in association with the identifier of the virtual printer. This prevents MFPs not satisfying the desirable conditions from requesting or executing the print jobs, whereby the user's trouble with checking the capabilities of the MFPs can be reduced.

The cloud server 120 according to the present exemplary embodiment stores the identifier of the MFP 110 transmitting the capability information if the received capability information satisfies the desirable conditions. However, this is not restrictive. For example, the cloud server 120 may store the received capability information about the MFP 110 and the name of the MFP 110 as well as the identifier of the MFP 110 transmitting the capability information. The cloud server 120 may also store state information about the MFP 110. The state information is information indicating whether to maintain the MFP 110 to be registered in the virtual printer in an activated state. An MFP 110 in the activated state can receive a print job from the cloud server 120. An MFP 110 not in the activated state is unable to receive a print job from the cloud server 120. Even if the MFP 110 is not in the activated state, the MFP 110 is registered in the virtual printer as one not in the activated state.

In step S1523, the CPU 301 transmits a registration result notification (Register-Output-Device-Response) indicating that the MFP 110 can be registered to the MFP 110 transmitting the IPP message.

For example, in the printing system discussed in Japanese Patent Application Laid-Open No. 2005-165393, an image forming apparatus not supporting PDF can execute a print job if the information processing apparatus such as a server converts the format of the print job as discussed in PWG “IPP Shared Infrastructure Extensions”, ftp://ftp.pwg.org/pub/pwg/ipp/wd/wd-ippsix10-20140226.pdf.

Suppose, however, that image data is encrypted as discussed in PWG “IPP Document Encryption”, http://ftp.pwg.org/pub/pwg/ipp/whitepaper/tb-doccrypt-20180205.pdf. In such a case, the information processing apparatus is unable to convert the print job into a format supported by the image forming apparatus since the information processing apparatus does not know the decryption key.

The image forming apparatus not satisfying the desirable conditions, even if registered in the virtual printer as with the case where the format of a print job can be converted (the print job is not encrypted), is therefore unable to execute the print job transmitted from a terminal apparatus. The information processing apparatus that registers an image forming apparatus not satisfying the desirable conditions in the virtual printer thus performs the following processing to allow the image forming apparatus registered in the virtual printer to execute the print job.

In steps S1524 to S1526, the CPU 301 checks whether the desirable conditions need to be modified based on the capability information about the MFP 110 transmitting the IPP message. Such an operation is for the case where the file format is unable to be converted because of encrypted printing. Suppose, for example, that no file format is specified in the file format item 807, and the MFP 111 supporting the PDF and PWG-Raster formats is registered. In such a case, if a PDF file is transmitted to the virtual printer, the MFP 111 can print the PDF file since the MFP 111 is capable of both PDF printing and PWG-Raster printing. Also, suppose that the MFP 112 not supporting PDF but encrypted printing is registered in the virtual printer after the MFP 111 supporting encrypted printing. In such a case, if an encrypted PDF job is transmitted to the virtual printer, the encrypted PDF job can be printed by the MFP 111 but not by the MFP 112. The reason is that the virtual printer is unable to convert the encrypted PDF job into a PWG-Raster job.

By performing the above processing, the information processing apparatus that registers an image forming apparatus not satisfying the desirable conditions in the virtual printer can allow the image forming apparatus registered in the virtual printer to execute the print job.

In step S1524, the CPU 301 determines whether encrypted printing is defined in the desirable conditions. More specifically, the CPU 301 determines whether the checkbox of the encrypted printing item 806 on the setting screen 800 is checked and the setting is stored. If the CPU 301 determines that encrypted printing is defined (YES in step S1524), the processing proceeds to step S1525 since the cloud server 120 is unable to convert a file format. If the CPU 301 determines that encrypted printing is not defined (NO in step S1524), the processing proceeds to step S1531 since the cloud server 120 can convert a file format.

In step S1525, the CPU 301 determines whether any file format is defined in the desirable conditions. More specifically, the CPU 301 refers to the desirable conditions that is the capability information stored in the HDD 304, and determines whether at least either one of the PDF and PWG-Raster formats is set as a file format in the desirable conditions. If the CPU 301 determines that any file format is already defined (YES in step S1525), the processing proceeds to step S1531. The reason is that the desirable conditions do not need to be updated since the file format is taken into account in determining whether the capability information satisfies the desirable conditions in step S1521. If the CPU 301 determines that no file format is defined (NO in step S1525), the processing proceeds to step S1526.

In step S1526, the CPU 301 modifies the desirable condition on the file format stored in the HDD 304 to the file format included in the capability information received in step S1501. For example, when the MFP 111 is initially registered in the virtual printer, the desirable condition on the file format is the PDF and PWG-Raster formats. If the MFP 112 is then registered in the virtual printer, the desirable condition on the file format is rewritten as the PWG-Raster format. If the desirable condition is rewritten in step S1526, a setting screen on which the desirable condition is reflected may be displayed when the user displays the setting screen 800 again. If the desirable condition is rewritten in step S1526, the terminal apparatus 131 may display a screen or notification indicating the modification of the desirable condition when connected to the cloud server 120.

In step S1530, the CPU 301 transmits a registration result notification (Register-Output-Device-Response) indicating that the MFP 110 transmitting the IPP message is not registrable to the MFP 110.

In step S1531, the CPU 301 turns off the registration request flag indicating that an MFP 110 is requesting registration. Specifically, the CPU 301 stores information indicating that registration is not being requested into the RAM 303.

By performing the foregoing processing, the user's trouble when an image forming apparatus receives an encrypted print job stored in the information processing apparatus from the information processing apparatus and executes the print job based on the user's operations can be reduced.

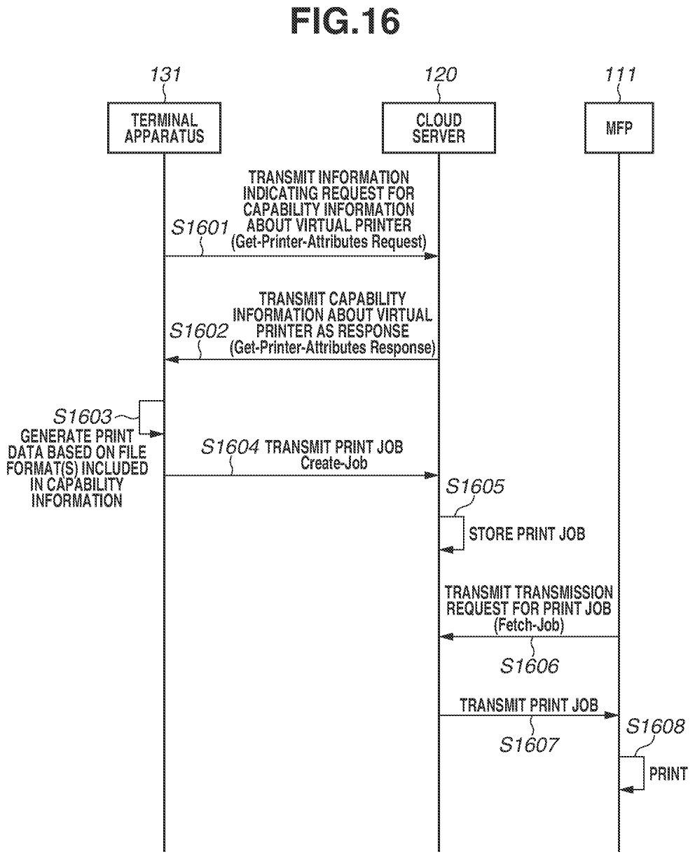

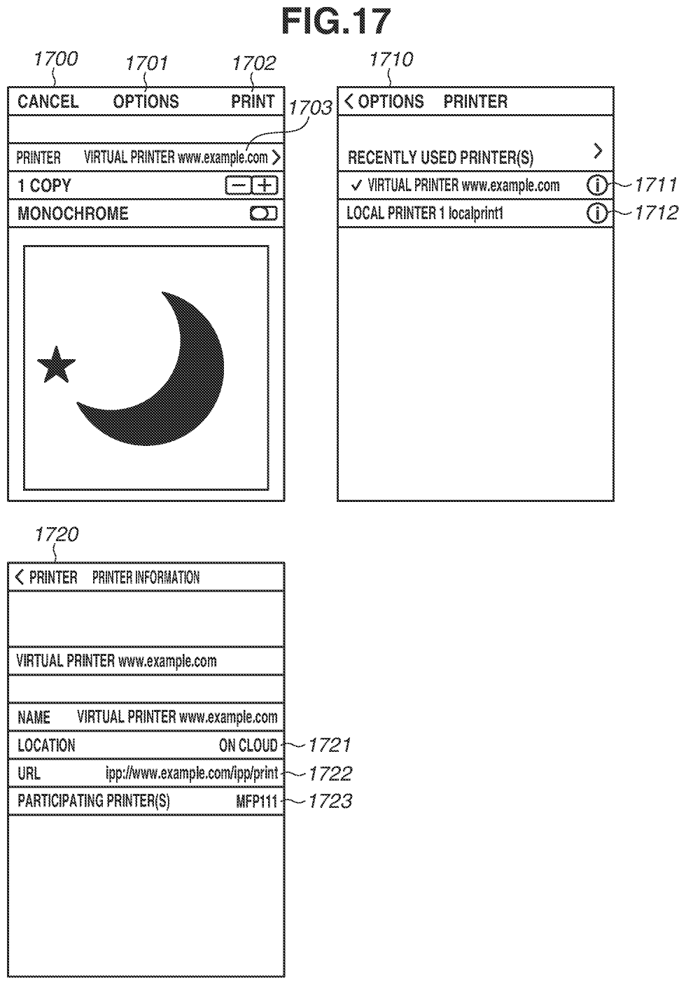

FIG. 16 is a diagram illustrating an example of a sequence of print processing where the terminal apparatus 131 transmits a print job to the cloud server 120 and the MFP 111 executes the print job. This sequence is started when the user operates the terminal apparatus 131 and gives an instruction to display a print setting screen 1700 illustrated in FIG. 17. The sequence is implemented by the apparatuses performing IPP communication.

In step S1601, the CPU 401 of the terminal apparatus 131 transmits information (Get-Printer-Attributes Request) indicating a request for capability information about the virtual printer to the cloud server 120. The capability information about the virtual printer refers to information indicating the functions supported by the virtual printer. Examples of the information indicating the functions (capabilities) supported by the virtual printer include “executability of two-sided printing”, “supported sheet sizes”, “postprocessing capabilities”, “encrypted printing”, and “file formats”.

In step S1602, the CPU 301 of the cloud server 120 receiving the information indicating a request for the capability information transmits the capability information about the virtual printer to the terminal apparatus 131 as a response (Get-Printer-Attributes Response).

In step S1603, the CPU 401 of the terminal apparatus 131 generates print data based on the file format(s) included in the capability information about the virtual printer, received in step S1602, in response to acceptance of a print instruction from the user. If the virtual printer supports only the PWG-Raster format, the CPU 401 generates the print data in the PWG-Raster format. The PWG-Raster format has the benefit of being printable in most printing apparatuses, but has difficulty in obtaining image quality at resolutions corresponding to the capabilities of the printing apparatuses. Print data is thus desirably generated in the PDF format if high priority is given to image quality.

In step S1604, the CPU 401 of the terminal apparatus 131 transmits the print job (Create-Job) to the cloud server 120 that is the virtual printer.

In step S1605, the CPU 301 of the cloud server 120 that is the virtual printer stores the print job into the HDD 304 in the cloud server 120.

In step S1606, the CPU 201 of the MFP 111, in response to acceptance of an execution instruction for the print job from the user, transmits a transmission request (Fetch-Job) for the print job corresponding to the execution instruction to the cloud server 120.

In step S1607, the cloud server 120 transmits the print job stored in step S1605 to the MFP 111 by IPP communication in response to the transmission request (Fetch-Job) for the print job, received from the MFP 111. Here, the print job associated with the user is transmitted to the MFP 111.

In step S1608, the MFP 111 receives the print job transmitted from the cloud server 120 and performs print processing. The present processing is ended.

A screen displayed on the operation unit 406 of the terminal apparatus 131 in instructing the virtual printer to perform printing will be described with reference to FIG. 17.

FIG. 17 is a diagram illustrating an example of a print setting screen displayed on the operation unit 406 of the terminal apparatus 131.

A print setting screen 1700 is a screen displayed on the operation unit 406 of the terminal apparatus 131. A print job is generated and transmitted to the cloud server 120 when the print setting screen 1700 is operated by the user.

An options button 1701 is a button used to display a screen for setting a printer to be used like a screen 1710 when selected by the user.

The print setting screen 1710 is a screen for selecting the printer to execute the print job. A check mark is displayed on the left of the name of the selected printer.

A button 1711 is a button for displaying detailed information about the “virtual printer www.example.com” when selected by the user. A print setting screen 1720 is the screen displayed here.

A button 1712 is a button for displaying detailed information about the “local printer 1 localprint1” when selected by the user.

The print setting screen 1720 is displayed when the button 1711 is selected, and displays detailed information about the “virtual printer www.example.com”.

An item 1721 indicates how the “virtual printer www.example.com” is connected to the terminal apparatus 131. An item 1722 indicates the URL of the “virtual printer www.example.com”. If the selected printer is a virtual printer like the “virtual printer www.example.com”, an item 1723 lists printers participating in the virtual printer.

A print button 1702 is a button for transmitting the print settings made on the print setting screen 1700 and the print job including the user-selected image data to the selected printer and causing the printer to perform print processing when selected by the user.

A printer button 1703 is a button for displaying the print setting screen 1720 displaying detailed information about the printer when selected by the user.

### Other Exemplary Embodiments

Processing in an exemplary embodiment of the present disclosure includes supplying a storage medium storing program code for implementing the functions of the foregoing exemplary embodiments to a system or an apparatus, and reading the program code stored in the storage medium by a computer (or CPU or microprocessing unit (MPU)) of the system or apparatus. In such a case, the program code itself read from the recording medium implements the functions of the foregoing exemplary embodiments, and the program code constitutes an exemplary embodiment of the present disclosure.

An exemplary embodiment of the present disclosure also covers a case where the functions of the foregoing exemplary embodiments are implemented by executing the read program code by the computer. An exemplary embodiment of the present disclosure also covers a case where an OS running on the computer performs part or all of the actual processing based on instructions of the program code, and the functions of the foregoing exemplary embodiments are implemented by such processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-241727, filed Dec. 25, 2018, which is hereby incorporated by reference herein in its entirety.

What is claimed is:

1. An information processing apparatus comprising:
a registration unit configured to register a first image forming apparatus in a virtual printer; and
a reception unit configured to receive capability information from the first image forming apparatus, wherein the capability information includes at least information indicating that the first image forming apparatus executes an encrypted print job,
wherein the registration unit is configured not to register a second image forming apparatus corresponding to predetermined capability information received by the reception unit, and
wherein the predetermined capability information does not include information that the second image forming apparatus executes the encrypted print job.

2. The information processing apparatus according to claim 1, further comprising an acceptance unit configured to accept information indicating a capability desirable for a third image forming apparatus to be registered in the virtual printer,
wherein, if the information accepted by the acceptance unit indicates that a capability to execute the encrypted print job is desirable for the third image forming apparatus, the registration unit does not register the second image forming apparatus corresponding to the predetermined capability information received by the reception unit, and
wherein, if the information accepted by the acceptance unit does not indicate that the capability to execute the encrypted print job is desirable for the third image forming apparatus, the registration unit registers the second image forming apparatus corresponding to the predetermined capability information received by the reception unit.

3. The information processing apparatus according to claim 1, further comprising a transmission unit configured to transmit, to the first image forming apparatus, information indicating whether the first image forming apparatus is successfully registered in the virtual printer by the registration unit.

4. The information processing apparatus according to claim 3, wherein information transmitted by the transmission unit and indicating that the first image forming apparatus is not successfully registered in the virtual printer includes information indicating a capability that the first image forming apparatus does not have among capabilities indicated by information accepted by an acceptance unit.

5. The information processing apparatus according to claim 1, further comprising:
a second reception unit configured to receive an identifier of the first image forming apparatus from the first image forming apparatus as a registration request; and
a request unit configured to request information indicating a capability of the first image forming apparatus to the first image forming apparatus based on reception of the identifier by the second reception unit.

6. The information processing apparatus according to claim 5, further comprising a first storage unit configured to store the identifier in a case where the predetermined capability information does not include the information indicating that the second image forming apparatus executes the encrypted print job.

7. The information processing apparatus according to claim 1, further comprising:
a second storage unit configured to store a print job transmitted from a terminal apparatus;
a third reception unit configured to receive information from the first image forming apparatus, wherein the information indicates a request to transmit the print job; and
a second transmission unit configured to transmit the print job stored in the second storage unit to the first image forming apparatus based on reception of the information indicating the request to transmit the print job by the third reception unit.

8. The information processing apparatus according to claim 1, wherein the information processing apparatus is a cloud server.

9. The information processing apparatus according to claim 1, wherein the information processing apparatus is an information processing apparatus supporting a predetermined printing protocol.

10. The information processing apparatus according to claim 9, wherein the predetermined printing protocol is an Internet Printing Protocol (IPP).

11. A method of controlling an information processing apparatus, the method comprising:
registering a first image forming apparatus in a virtual printer;
receiving capability information from the first image forming apparatus, wherein the capability information includes at least information indicating that the first image forming apparatus executes an encrypted print job; and
not registering a second image forming apparatus corresponding to received predetermined capability information,
wherein the predetermined capability information does not include information that the second image forming apparatus executes the encrypted print job.

12. A non-transitory computer-readable storage medium storing a program that, when executed by a computer, causes the computer to perform a method of controlling an information processing apparatus, the method comprising:
registering a first image forming apparatus in a virtual printer;
receiving capability information from the first image forming apparatus, wherein the capability information includes at least information indicating that the first image forming apparatus executes an encrypted print job; and
not registering a second image forming apparatus corresponding to received predetermined capability information,
wherein the predetermined capability information does not include information that the second image forming apparatus executes the encrypted print job.

13. The storage medium according to claim 12, the method further comprising accepting information indicating a capability desirable for a third image forming apparatus to be registered in the virtual printer,
wherein, if the accepted information indicates that a capability to execute the encrypted print job is desirable for the third image forming apparatus, registering includes not registering the second image forming apparatus corresponding to the received predetermined capability, and
wherein, if the accepted information does not indicate that the capability to execute the encrypted print job is desirable for the third image forming apparatus, registering includes registering the second image forming apparatus corresponding to the received predetermined capability information.

14. The storage medium according to claim 12, the method further comprising transmitting, to the first image forming apparatus, information indicating whether the first image forming apparatus is successfully registered in the virtual printer.

15. The storage medium according to claim 14, wherein transmitted information indicating that the first image forming apparatus is not successfully registered in the virtual printer includes information indicating a capability that the first image forming apparatus does not have among capabilities indicated by accepted information.

16. The storage medium according to claim 12, the method further comprising:
receiving an identifier of the first image forming apparatus from the first image forming apparatus as a registration request; and
requesting information indicating a capability of the first image forming apparatus to the first image forming apparatus based on reception of the identifier.

17. The storage medium according to claim 16, the method further comprising storing the identifier in a case where the predetermined capability information does not include the information indicating that the second image forming apparatus executes the encrypted print job.

18. The storage medium according to claim 12, the method further comprising:
storing a print job transmitted from a terminal apparatus;
receiving information from the first image forming apparatus, wherein the information indicates a request to transmit the print job; and
transmitting the stored print job to the first image forming apparatus based on reception of the information indicating the request to transmit the print job.

19. The storage medium according to claim 12, wherein the first image forming apparatus is an image forming apparatus supporting a predetermined printing protocol.

20. The storage medium according to claim 19, wherein the predetermined printing protocol is an Internet Printing Protocol (IPP).
